(19) United States
(12) Patent Application Publication
(10) Pub. No.: US 2006/0138048 A1
(43) Pub. Date: Jun. 29, 2006

(54) Method for treating a contaminated fluid, system for treating a contaminated fluid, and method for making a biomass carrier suitable for treating a contaminated fluid

(75) Inventors: Yen-Jung Hu, Hsin-Chu City (TW); Hsi-Yu Chen, Tainan City (TW); Wen-Yu Lu, Tainan Hsien (TW)

Correspondence Address: BANNER & WITCOFF, 1001 G STREET N W, SUITE 1100, WASHINGTON, DC, 20001, US

(73) Assignee: Kang Na Hsiung Enterprise Co., Ltd., Tainan Hsien (TW)

(21) Appl. No.: 11/313,827

(22) Filed: Dec. 22, 2005

(30) Foreign Application Priority Data
Dec. 27, 2004 (TW) 093140773
Oct. 6, 2005 (TW) 094134949

(51) Int. Cl. C02F 3/00

(52) U.S. Cl. 210/616; 210/150

(57) ABSTRACT

A method for treating a contaminated fluid includes: preparing biomass-carrier pieces made from a fiber component selected from a non-woven fabric, a fiber bundle assembly, a bulky fiber bundle assembly, a woven fabric, and a braided strap; and mixing the biomass-carrier pieces with the contaminated fluid, so as to remove the contaminated parts of the contaminated fluid. A system for treating a contaminated fluid, and a method for making a biomass carrier suitable for treating a contaminated fluid are also disclosed. The biomass carrier thus made has a minimum thickness region at a bonding line, so as to reinforce the structure of the biomass carrier, and a loose region surrounding the minimum thickness region, so as to improve attachment of microorganisms thereon and facilitate immersion into water.

### CROSS-REFERENCE TO RELATED APPLICATION

This application claims priority of Taiwanese application nos. 093140773 and 094134949, filed on Dec. 27, 2004 and Oct. 6, 2005, respectively.

### BACKGROUND OF THE INVENTION

1. Field of the Invention

This invention relates to a method for treating a contaminated fluid, more particularly to a method for treating a contaminated fluid by using biomass-carrier pieces. In addition, a system for treating the contaminated fluid, and a method for making a biomass carrier suitable for treating the contaminated fluid are also disclosed.

2. Description of the Related Art

Conventional methods for treating a contaminated influent, such as wastewater or waste gas, include chemical and physical treatments, such as filtration or addition of chemicals. With the development of biotechnology, many biological methods that involve decomposition of contaminants in an influent by microorganisms have been proposed. However, since cell counts and survival time of the microorganisms are hard to control, in practice, an environment favorable to growth of the microorganisms is provided in these biological methods. In order to effectively control cell numbers of the microorganisms, the environment favorable to growth of the microorganisms is provided through a biomass carrier.

The traditional biomass carriers suitable for growth of microorganisms and decomposition of contaminants include an immobilized type of biomass carrier and a fixed-film type of biomass carrier. Chinese Utility Model application no. CN2132750Y discloses one example of the immobilized type of biomass carrier, which is in the form of a membrane carrier that includes a support layer made from a fabric web, two gel films attached to two sides of the support layer, respectively, and microorganisms and enzymes immobilized in the two gel films. Chinese Patent Publication no. CN1298018A discloses another example of the immobilized type of biomass carrier, which is in the form of a coated core carrier. The coated core carrier is prepared by the steps of: preparing a core made from an insoluble material; forming a coating on the surface of the core; activating the coating formed on the surface of the core; and bonding a biomaterial to the activated coating formed on the surface of the core. However, during manufacture of the immobilized type of biomass carrier, species of the microorganisms are chosen first based on the properties of the contaminants in the fluid to be treated, and the microorganisms of the chosen species are subsequently cultivated and proliferated and are finally immobilized in the biomass carrier. Therefore, the manufacture of the traditional immobilized type of biomass carrier is complicated, and the production cost is accordingly high.

As for the traditional fixed-film type of biomass carrier, European Patent no. 0433139 discloses a bed of biomass granulates used in a process for aerobic biological nitrification. The bed of biomass granulates includes support granulates based on carbonates, and nitrifying microorganisms adhered to the support granulates. However, effluent disposal through the bed of biomass granulates requires an aeration column, a biological nitrification reactor column, a setter column, and a debubbler column. Therefore, the process for aerobic biological nitrification of European Patent no. 0433139 is complicated and inefficient.

Canadian Patent no. 1217581 discloses an apparatus for the biological treatment of wastewater that includes biomass, and carrier materials such as polyurethane foam particles used as a settling surface for the biomass. However, since pores of the polyurethane foam are not communicated with each other, it is difficult to make best use of such polyurethane foam. In addition, during operation of the apparatus of Canadian Patent no. 1217581, it takes a relatively long time to submerge the polyurethane foam in the wastewater, which results in relatively poor bio-treatment efficiency.

Taiwanese Patent Publication no. 513449 discloses a copolymer foam made from a copolymer of polyvinyl alcohol, chitosan and polyisocyanate. Active carbon powders are trapped in pores of the copolymer foam so as to facilitate growth of microorganisms. Production cost of the copolymer is not economical because of the need to prepare a prepolymer of chitosan and polyisocyanate.

Taiwanese Patent Publication no. 593168 discloses a method for treating wastewater with fixed-film microorganisms on porous carriers. The porous carriers include a polymer foam, and adsorbent particles selected from the group consisting of active carbon, diatomite, and zeolite and entrapped in pores of the polymer foam. However, manufacture of the porous carriers is relatively complicated since further hydrophilic treatments are required to reduce the time required for submerging the polymer foam in the wastewater.

Hence, there is a need in the art to provide a method and a system for treating a contaminated fluid by the use of biomass carriers which can be easily and economically produced, and a method for making the biomass carrier that is capable of being immersed in water quickly and that has a large surface area.

### SUMMARY OF THE INVENTION

Therefore, the object of the present invention is to provide a method for treating a contaminated fluid, a system for treating a contaminated fluid, and a method for making a biomass carrier suitable for treating a contaminated fluid that can alleviate at least one of the aforesaid drawbacks of the prior art.

According to one aspect of this invention, a method for treating a contaminated fluid includes preparing biomass-carrier pieces, each of which is independently made from a fiber component selected from the group consisting of a non-woven fabric, a fiber bundle assembly, a bulky fiber bundle assembly, a woven fabric, and a braided strap, and mixing the biomass-carrier pieces with the contaminated fluid.

According to another aspect of this invention, a system for treating a contaminated fluid includes a tank for receiving the contaminated fluid, and biomass-carrier pieces disposed in the tank for contacting the contaminated fluid. Each of the biomass-carrier pieces is independently made from a fiber component selected from the group consisting of a non-woven fabric, a fiber bundle assembly, a bulky fiber bundle assembly, a woven fabric and a braided strap.

According to yet another aspect of this invention, a method for making a biomass carrier suitable for treating a contaminated fluid includes: preparing a fiber bale essentially consisted of fibers; opening and scutching the fiber bale; carding the opened and scutched fiber bale so as to form a loosened fiber web; lapping a plurality of the loosened fiber webs to a predetermined thickness; consolidating the fibers of the loosened fiber webs so as to form the loosened fiber webs into a non-woven fabric; and structurally reinforcing the non-woven fabric by bonding the fibers of the non-woven fabric along at least one bonding line such that the thickness of the non-woven fabric is smallest at the bonding line.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a perspective view of the first preferred embodiment of a fiber component used in the preferred embodiment of a method for treating a contaminated fluid according to this invention;

FIG. 2 is a perspective view of the second preferred embodiment of a fiber component used in the preferred embodiment of a method for treating a contaminated fluid according to this invention;

FIG. 3 is a perspective view of the third preferred embodiment of a fiber component used in the preferred embodiment of a method for treating a contaminated fluid according to this invention;

FIG. 4 is a perspective view of the fourth preferred embodiment of a fiber component used in the preferred embodiment of a method for treating a contaminated fluid according to this invention;

FIG. 5 is a perspective view of the fifth preferred embodiment of a fiber component used in the preferred embodiment of a method for treating a contaminated fluid according to this invention;

FIG. 6 is a flow diagram to illustrate consecutive steps of the first preferred embodiment of a method for making a biomass carrier suitable for treating a contaminated fluid according to this invention;

FIG. 7 is a perspective view of the first prepared embodiment of a method for making a biomass carrier according to this invention, illustrating how a non-woven fabric is structurally reinforced through bonding along two bonding lines parallel to a longitudinal direction of the non-woven fabric, and how the reinforced non-woven fabric is cut in a direction transverse to the longitudinal direction of the non-woven fabric;

FIG. 8 is a perspective view of the second preferred embodiment of a method for making a biomass carrier according to this invention, illustrating how a non-woven fabric is structurally reinforced through bonding along one bonding line parallel to a longitudinal direction of the non-woven fabric, and how the reinforced non-woven fabric is cut in a direction transverse to the longitudinal direction of the non-woven fabric;

FIG. 9 is a perspective view of the third preferred embodiment of a method for making a biomass carrier according to this invention, illustrating how a non-woven fabric is structurally reinforced through bonding along a plurality of bonding lines transverse to a longitudinal direction of the non-woven fabric, and how the reinforced non-woven fabric is cut in a direction transverse to the longitudinal direction of the non-woven fabric;

FIG. 10 is a perspective view of the fourth preferred embodiment of a method for making a biomass carrier according to this invention, illustrating how a non-woven fabric is structurally reinforced through bonding along a plurality of bonding lines transverse to a longitudinal direction of the non-woven fabric, and how the reinforced non-woven fabric is cut in directions parallel and transverse to the longitudinal direction of the non-woven fabric;

FIG. 11 is a schematic view to illustrate the first preferred embodiment of a system for treating a contaminated fluid according to this invention; and

FIG. 12 is a schematic view to illustrate the second preferred embodiment of a system for treating a contaminated fluid according to this invention.

### DETAILED DESCRIPTION OF THE PREFERRED EMBODIMENTS

The preferred embodiment of a method for treating a contaminated fluid according to this invention includes preparing biomass-carrier pieces, and mixing the biomass-carrier pieces with the contaminated fluid. Each of the biomass-carrier pieces is independently made from a fiber component selected from the group consisting of a non-woven fabric, a fiber bundle assembly, a bulky fiber bundle assembly, a woven fabric, and a braided strap.

The term “contaminated fluid” as used herein means a fluid containing contaminants such as biodegradable contaminants or suspended solids, and includes waste gases, or wastewater, such as industrial wastewater and domestic wastewater.

Preferably, during the mixing of the biomass-carrier pieces with the contaminated fluid, the biomass-carrier pieces are freely suspended in the contaminated fluid, and move with the flow of the contaminated fluid, so as to enhance the contact between the contaminated fluid and the biomass-carrier pieces. Alternatively, the biomass-carrier pieces can be collected together, and subsequently brought into contact with the contaminated fluid in an unmovable manner. During contact of the biomass-carrier pieces with the contaminated fluid, the contaminants in the contaminated fluid will be decomposed or entrapped by the biomass-carrier pieces.

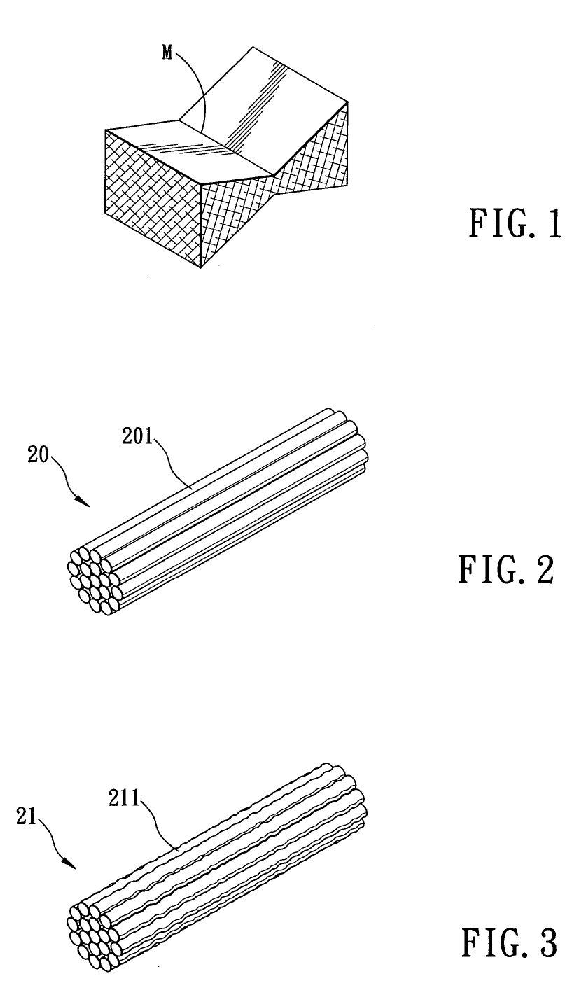

Volume of the biomass-carrier pieces vary based on the volume of the contaminated fluid to be treated. The first preferred embodiment of the fiber component used for making the biomass-carrier pieces is made of a non-woven fabric. The non-woven fabric preferably has a shape selected from the group consisting of a cylinder and a polyhedral prism, such as a pentagonal prism or a hexagonal prism. Referring to FIG. 1, the first preferred embodiment of the fiber component is structurally reinforced through formation of a bonding line (M) in such a manner that the thickness of each of the biomass-carrier pieces is smallest at the bonding line (M).

Referring to FIG. 2, the second preferred embodiment of the fiber component used for making the biomass-carrier pieces is a fiber bundle assembly 20. The fiber bundle assembly 20 is prepared by doubling and consolidating a plurality of fiber bundles 201, followed by cutting the doubled and consolidated fiber bundles 201.

Referring to FIG. 3, the third preferred embodiment of the fiber component used for making the biomass-carrier pieces is a bulky fiber bundle assembly 21. The bulky fiber bundle assembly 21 is prepared by texturing, doubling and consolidating a plurality of bulky fiber bundles 211, followed by cutting the bulky fiber bundles 211.

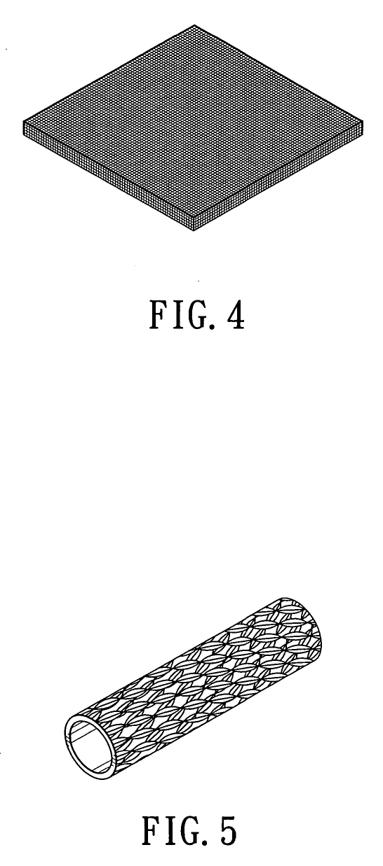

Referring to FIG. 4, the fourth preferred embodiment of the fiber component used for making the biomass-carrier pieces is a woven fabric. The woven fabric is prepared by weaving and consolidating processes, followed by cutting the consolidated woven fabric.

Referring to FIG. 5, the fifth preferred embodiment of the fiber component used for making the biomass-carrier pieces is a braided strap. The braided strap is prepared by braiding and consolidating processes, followed by cutting the braided and consolidated strap.

Preferably, the biomass-carrier pieces have a total apparent volume percentage ranging from 10% to 90% based on the volume of the contaminated fluid. More preferably, the biomass-carrier pieces have a total apparent volume percentage ranging from 50% to 80% based on the volume of the contaminated fluid.

In addition, the fiber component is preferably made from a polymer selected from the group consisting of polyester, polycarbonate, polyamide, polyolefin, polyacrylate, polyethylene glycol, polyvinyl chloride, polyvinyl fluoride, polystyrene, and combinations thereof. More preferably, the fiber component is made from a polymer selected from the group consisting of polyethylene, polypropylene, polyethylene terethphalate, polymethyl methacrylate, polycarbonate, polystyrene, and combinations thereof.

The preferred embodiment of a method for treating a contaminated fluid according to this invention further includes a seeding process, i.e., treating the biomass-carrier pieces with a mixture of an active sludge and clear water prior to the mixing of the biomass-carrier pieces with the contaminated fluid. Acclimation of the active sludge on the biomass-carrier pieces can be conducted under an aerobic or anaerobic environment for 4 to 8 hours based on the method used in the active sludge treatment known in the art.

Alternatively, the preferred embodiment of a method for treating a contaminated fluid according to this invention further includes the step of adding an additive, such as a chemical reagent or a photocatalyst, into the contaminated fluid to enhance treatment efficiency.

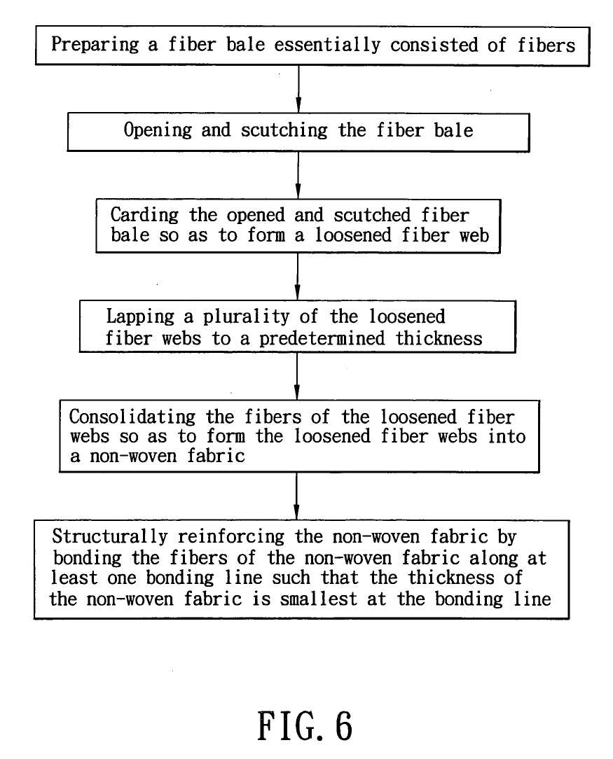

Referring to FIG. 6, the first preferred embodiment of a method for making a biomass carrier suitable for treating a contaminated fluid according to this invention includes the steps of: preparing a fiber bale essentially consisted of fibers; opening and scutching the fiber bale; carding the opened and scutched fiber bale so as to form a loosened fiber web; lapping a plurality of the loosened fiber webs to a predetermined thickness; consolidating the fibers of the loosened fiber webs so as to form the loosened fiber webs into a non-woven fabric; and structurally reinforcing the non-woven fabric by bonding the fibers of the non-woven fabric along at least one bonding line such that the thickness of the non-woven fabric is smallest at the bonding line.

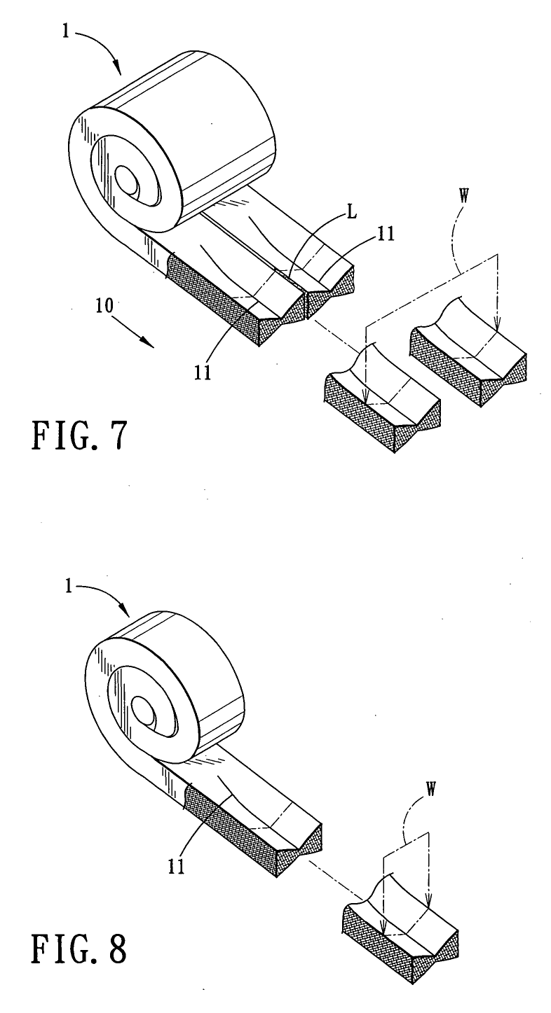

In the first preferred embodiment shown in FIG. 7, the non-woven fabric is formed into a roll 1 after the consolidating operation. The roll 1 of the non-woven fabric is formed with two of the bonding lines 11 after the reinforcing operation. Preferably, the bonding lines 11 are parallel to each other and to a longitudinal direction of the non-woven fabric (as indicated by an arrow 10). Preferably, the bonding lines 11 are separated from each other by a distance ranging from 0.5 to 5 centimeters.

The porous non-woven fabric is first cut along a cutting line (L) that is positioned between the bonding lines 11 and that is parallel to the longitudinal direction of the non-woven fabric, and is subsequently cut along cutting lines (W) that are transverse to the longitudinal direction of the non-woven fabric. The biomass carriers obtained after the cutting process have a shape similar to that of the fiber component shown in FIG. 1. Each of the biomass carriers includes a minimum thickness region formed by the bonding line 11 and a loose region surrounding the minimum thickness region. The loose region is adapted for attachment by microorganisms useful for bio-treatments. Preferably, each of the biomass carriers is 1.5 cm in width, 1.5 cm in length and 1.5 cm in maximum thickness at two ends.

Preferably, the consolidating operation of the fibers of the loosened fiber webs is conducted through a technique selected from the group consisting of chemical bonding, thermal bonding, water-jet entangling, and needle punching. For example, the fibers of the loosened fiber webs can be consolidated through thermal bonding at a temperature of 135° C. for about 6 seconds, so as to form the non-woven fabric.

Preferably, the bonding operation of the fibers of the non-woven fabric is conducted through a technique selected from the group consisting of stitching, thermal bonding, and ultrasonic bonding.

In addition, each of the fibers of the fiber bale is preferably made from a single-component material selected from the group consisting of polyester, polycarbonate, polyamide, polyolefin, polyacrylate, polyethylene glycol, polyvinyl chloride, polyvinyl fluoride, polystyrene, and combinations thereof. More preferably, each of the fibers of the fiber bale is made from a single-component material selected from the group consisting of polyethylene, polypropylene, polyethylene terethphalate, polymethyl methacrylate, polycarbonate, polystyrene, and combinations thereof.

Alternatively, each of the fibers of the fiber bale is preferably made from a sheath/core type bicomponent fiber that includes a first component and a second component having a melting point 10° C. higher than that of the first component. More preferably, the first component is polypropylene, and the second component is polyethylene.

Referring to FIG. 8, the second preferred embodiment of the method of this invention is shown to be similar to the first preferred embodiment, except that the non-woven fabric is structurally reinforced through bonding along one bonding line 11.

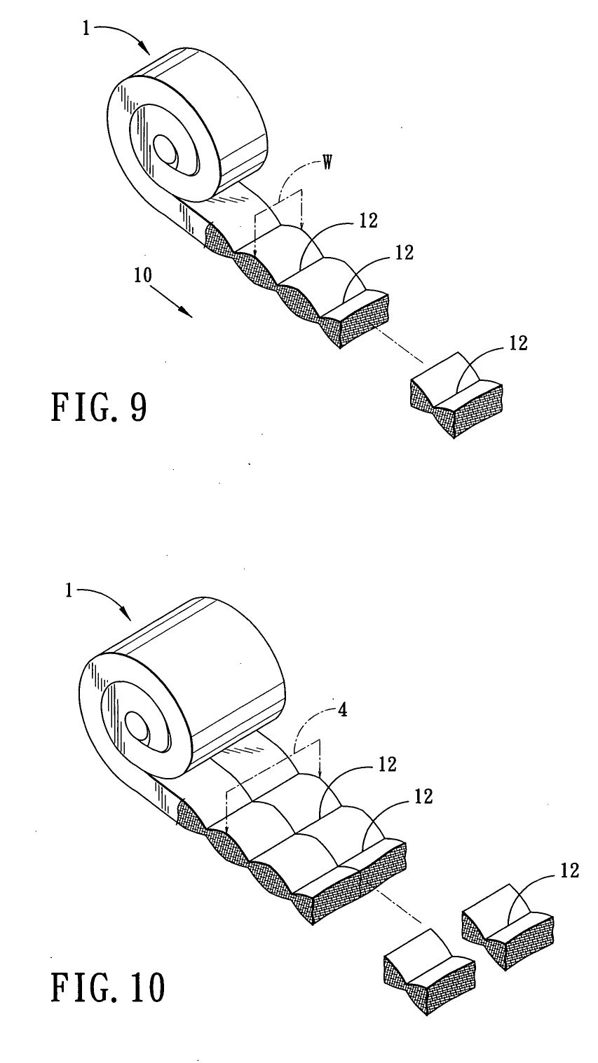

Referring to FIG. 9, the third preferred embodiment of the method of this invention is shown to be similar to the first preferred embodiment, except that the non-woven fabric is structurally reinforced through bonding along a plurality of bonding lines 12, each of which is transverse to the longitudinal direction of the non-woven fabric, and that the reinforced non-woven fabric is cut along a plurality of cutting lines (W), each of which is positioned between two adjacent bonding lines 12.

Referring to FIG. 10, the fourth preferred embodiment of the method of this invention is shown to be similar to the third preferred embodiment, except that the reinforced non-woven fabric is cut along a plurality of first cutting lines (W), each of which is positioned between two adjacent bonding lines 12. The reinforced non-woven fabric is also cut along the longitudinal direction of the non-woven fabric.

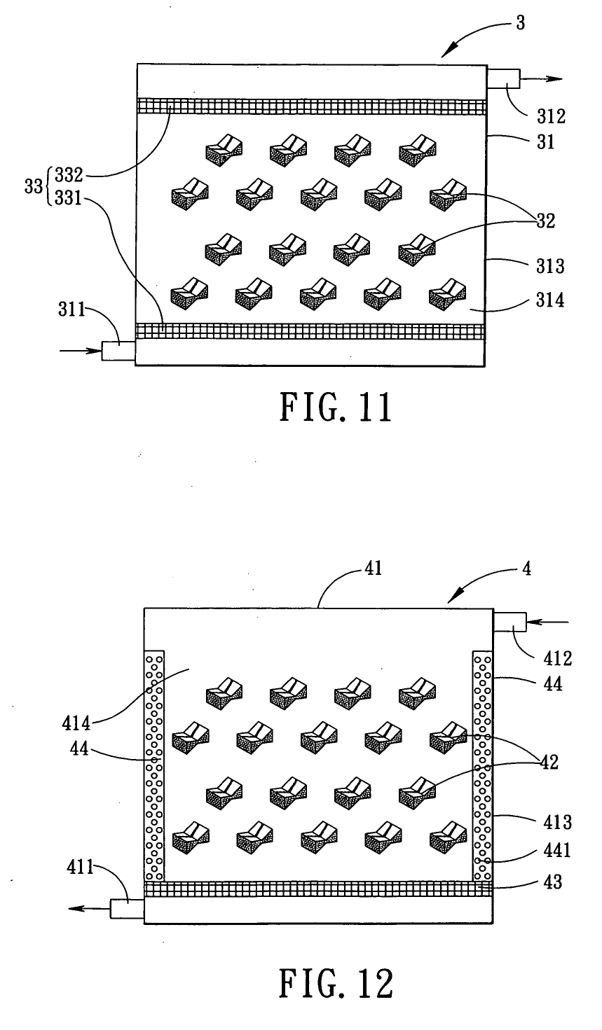

Referring to FIG. 11, the first preferred embodiment of a system 3 for treating a contaminated fluid according to this invention includes a tank 31 for receiving the contaminated fluid, and biomass-carrier pieces 32 disposed in the tank 31 for contacting the contaminated fluid. Each of the biomass-carrier pieces 32 is independently made from a fiber component selected from the group consisting of a non-woven fabric, a fiber bundle assembly 20, a bulky fiber bundle assembly 21, a woven fabric and knitted fiber strap.

In addition, the tank 31 includes an inlet 311 disposed in a bottom portion of the tank 31, an outlet 312 disposed in a top portion of the tank 31 and opposite to the inlet 311, and a separator unit 33 disposed between the inlet 311 and the outlet 312. The separator unit 33 includes a first porous plate 331 located downstream of the inlet 311, and a second porous plate 332 located upstream of the outlet 312. The biomass-carrier pieces 32 are freely suspended in the contaminated fluid in the space 314 confined by first and second porous plates 331, 332 and the peripheral wall 313 of the tank 31.

By virtue of the arrangement of the inlet 311 and the outlet 312, the contaminated fluid cane brought into contact with the biomass-carrier pieces 32, and the time spent by the contaminated fluid in the tank 31 can be increased.

Preferably, the biomass-carrier pieces 32 have a total apparent volume percentage ranging from 10% to 90% based on the volume of the contaminated fluid. More preferably, the biomass-carrier pieces 32 have a total apparent volume percentage ranging from 50% to 80% based on the volume of the contaminated fluid.

Optionally, each of the biomass-carrier pieces 32 is treated with a mixture of an active sludge and clean water.

Referring to FIG. 12, the second preferred embodiment of a system 4 for treating a contaminated fluid according to this invention includes a tank 41 for receiving the contaminated fluid, and biomass-carrier pieces 42 disposed in the tank 41 for contacting the contaminated fluid. Each of the biomass-carrier pieces 42 is independently made from a fiber component similar to the fiber component used for making the biomass-carrier pieces 32 of the first preferred embodiment.

In addition, the tank 41 includes an outlet 411 disposed in the bottom portion of the tank 41, an inlet 412 disposed in the upper portion of the tank 41 and opposite to the outlet 411, a porous plate 43 disposed upstream of the outlet 411 and downstream of the inlet 412, and a diffuser 44 disposed around the peripheral wall 413 of the tank 41 and upstream of the porous plate 43.

The biomass-carrier pieces 42 are freely suspended in the space 414 that is below the inlet 412 and that is confined by the porous plate 43 and the diffuser 44. Gas provided by the diffuser 44 through holes 441 assists in ensuring sufficient contact of the contaminated fluid with the biomass-carrier pieces 42. Cleaning of the biomass-carrier pieces 42 is conducted through a backwash process.

### EXAMPLES

### Example 1

### Preparation of Biomass Carriers

A core-sheath type bicomponent fiber that includes a first component of polyethylene and a second component of polypropylene (trade name: SP-2650EP, available from Far Eastern Textile Ltd., Taiwan) was used in the preparation of the biomass carriers. The core-sheath type bicomponent fiber had a fiber fineness of 6 deniers and a length of 5.1 cm. Initially, the fibers were opened, scutched, carded, and lapped, so as to form loosened fiber webs. The loosened fiber webs were consolidated by needle punching and hot-air processing to form a non-woven fabric that had a basis weight of 500 g/m² and a width of 1.8 m. The non-woven fabric was subsequently cut along a longitudinal direction thereof into a plurality of non-woven strips, each of which had a width of 0.6 m. Each of the non-woven strips was structurally reinforced by bonding along a plurality of bonding lines parallel to the longitudinal direction of the non-woven strip such that the thickness of the non-woven strip was smallest at each of the bonding lines. The bonding lines were parallel to each other and were separated from each other by a distance of 3 cm. Each of the non-woven strips was then cut along a plurality of first cutting lines (L), each of which was positioned between two adjacent bonding lines, and was further cut along a plurality of second cutting lines (W) transverse to the longitudinal direction of the non-woven strip, so as to form a plurality of biomass carriers, each of which was 1.5 cm long and 1.5 cm wide, and each of which had a maximum height of 1.5 cm at two ends thereof.

### Example 2

### Use of the Biomass Carriers Obtained from Example 1 in a System for Treating a Contaminated Fluid

The biomass carriers 42 obtained from Example 1 were then used in the system 4 for treating a contaminated fluid shown in FIG. 12. The tank 41 of the system 4 was available for receiving 500 liters of a contaminated fluid. 300 liters of the contaminated fluid having a turbidity of 11800 NTU (Nephelometric Turbidity Unit) was pumped into the tank 41 though the inlet 412. Each of the biomass carriers obtained from Example 1 has an apparent volume of 3.375 cm³. The total apparent percentage of the biomass carriers was 80% based on the volume of the contaminated fluid, i.e., 240 liters.

A flow meter for controlling inflow volume and rate of the contaminated fluid (not shown in FIG. 12) was mounted at the inlet 412. The turbidity of the contaminated fluid that flowed into the system 4 (Turbidity before treatment) and the turbidity of the contaminated fluid that flowed out of the system 4 (Turbidity after treatment) were measured, and reduction percentage (%) in the turbidity of the contaminated fluid was calculated according to the following formula. The results are shown in Table I:
Reduction percentage in the turbidity (%)=[(Turbidity_{after treatment}−Turbidity_{before treatment})/Turbidity_{before treatment}]×100%

TABLE I

| | Inflow rate of the | | Reduction |
|---|---|---|---|
| | contaminated fluid | Turbidity _{after treatment} | percentage of the |
| Test No. | (m³/day) | (NTU) | turbidity (%) |
| 1 | 22 | 1100 | 90.7 |
| 2 | 35 | 2500 | 78.8 |

### Example 3

### Use of the Biomass Carriers Obtained from Example 1 in a System for Treating a Contaminated Fluid

The biomass carriers 32 obtained from Example 1 were then used in the system 3 for treating a contaminated fluid shown in FIG. 11. The biomass carriers 32 were treated with a mixture of an active sludge and clean water in the tank 31 in advance for 8 hours. The active sludge was obtained from a wastewater recovery tank of a laundry plant. The contaminated fluid was retained in the tank 31 for 12 hours. The chemical oxygen demand (COD) value and suspended solid (SS) values of the contaminated fluid that flowed into and out of the system 3 were measured. It was found that after being treated by the system 3, the COD value of the contaminated fluid was reduced from 210 mg/L to 72 mg/L and the SS value of the contaminated fluid was reduced from 168 mg/L to 15 mg/L.

The results of the Examples show that the biomass-carrier pieces 32, 42 can serve as a filter and are efficient in removing suspended solids from contaminated fluid, and that the biomass-carrier pieces 32, 42 can provide a large surface area for attachment of the microorganisms which can enhance bio-decomposition of organic substances in the contaminated fluid.

While the present invention has been described in connection with what is considered the most practical and preferred embodiments, it is understood that this invention is not limited to the disclosed embodiments but is intended to cover various arrangements included within the spirit and scope of the broadest interpretation and equivalent arrangements.

What is claimed is:

1. A method for treating a contaminated fluid, comprising:
preparing biomass-carrier pieces, each of which is independently made from a fiber component selected from the group consisting of a non-woven fabric, a fiber bundle assembly, a bulky fiber bundle assembly, a woven fabric, and a braided strap; and
mixing the biomass-carrier pieces with the contaminated fluid.

2. The method of claim 1, wherein the biomass-carrier pieces are freely suspended in the contaminated fluid.

3. The method of claim 1, wherein each of the biomass-carrier pieces has a shape selected from the group consisting of a cylinder and a polyhedral prism.

4. The method of claim 1, wherein each of the biomass-carrier pieces is structurally reinforced through formation of a bonding line in such a manner that the thickness of each of the biomass-carrier pieces is smallest at the bonding line.

5. The method of claim 1, wherein the biomass-carrier pieces have a total apparent volume percentage ranging from 10% to 90% based on the volume of the contaminated fluid.

6. The method of claim 5, wherein the biomass-carrier pieces have a total apparent volume percentage ranging from 50% to 80% based on the volume of the contaminated fluid.

7. The method of claim 1, wherein the fiber component is made from a polymer selected from the group consisting of polyester, polycarbonate, polyamide, polyolefin, polyacrylate, polyethylene glycol, polyvinyl chloride, polyvinyl fluoride, polystyrene, and combinations thereof.

8. The method of claim 1, wherein the fiber component is made from a polymer selected from the group consisting of polyethylene, polypropylene, polyethylene terethphalate, polymethyl methacrylate, polycarbonate, polystyrene, and combinations thereof.

9. The method of claim 1, further comprising a seeding process of treating the biomass-carrier pieces with a mixture of an active sludge and clear water prior to the mixing of the biomass-carrier pieces with the contaminated fluid.

10. A system for treating a contaminated fluid, comprising:
a tank for receiving the contaminated fluid; and
biomass-carrier pieces disposed in said tank for contacting the contaminated fluid,
wherein each of said biomass-carrier pieces is independently made from a fiber component selected from the group consisting of a non-woven fabric, a fiber bundle assembly, a bulky fiber bundle assembly, a woven fabric and a braided strap.

11. The system of claim 10, wherein said biomass-carrier pieces have a total apparent volume percentage ranging from 10% to 90% based on the volume of the contaminated fluid.

12. The system of claim 11, wherein said biomass-carrier pieces have a total apparent volume percentage ranging from 50% to 80% based on the volume of the contaminated fluid.

13. The system of claim 10, wherein each of said biomass-carrier pieces is treated with a mixture of an active sludge and clear water.

14. A method for making a biomass carrier suitable for treating a contaminated fluid, comprising:
preparing a fiber bale consisted essentially of fibers;
opening and scutching the fiber bale;
carding the opened and scutched fiber bale so as to form a loosened fiber web;
lapping a plurality of the loosened fiber webs to a predetermined thickness;
consolidating the fibers of the loosened fiber webs so as to form the loosened fiber webs into a non-woven fabric; and
structurally reinforcing the non-woven fabric by bonding the fibers of the non-woven fabric along at least one bonding line such that the thickness of the non-woven fabric is smallest at the bonding line.

15. The method of claim 14, wherein the non-woven fabric is formed with two of the bonding lines after the reinforcing operation, the bonding lines being parallel to each other and being separated from each other by a distance ranging from 0.5 to 5 centimeters.

16. The method of claim 14, wherein the non-woven fabric is in the form of a roll, the bonding line being parallel to a longitudinal direction of the non-woven fabric in an extended state.

17. The method of claim 14, wherein the bonding line is transverse to a longitudinal direction of the non-woven fabric in an extended state.

18. The method of claim 14, wherein each of the fibers of the fiber bale is made from a single-component material selected from the group consisting of polyester, polycarbonate, polyamide, polyolefin, polyacrylate, polyethylene glycol, polyvinyl chloride, polyvinyl fluoride, polystyrene, and combinations thereof.

19. The method of claim 14, wherein each of the fibers of the fiber bale is made from a single-component material selected from the group consisting of polyethylene, polypropylene, polyethylene terethphalate, polymethyl methacrylate, polycarbonate, polystyrene, and combinations thereof.

20. The method of claim 14, wherein each of the fibers of the fiber bale is made from a sheath/core type bicomponent fiber that includes a first component and a second component having a melting point 10° C. higher than that of the first component.

21. The method as claimed in claim 20, wherein the first component is polypropylene, and the second component is polyethylene.

22. The method as claimed in claim 14, wherein the consolidating operation is conducted through a technique selected from the group consisting of chemical bonding, thermal bonding, water-jet entangling, and needle punching.

23. The method as claimed in claim 14, wherein the bonding operation is conducted through a technique selected from the group consisting of stitching, thermal bonding, and ultrasonic bonding.
